(19) United States
(12) Patent Application Publication
(10) Pub. No.: US 2024/0015650 A1
(43) Pub. Date: Jan. 11, 2024

(54) CONFIGURATION OF REFERENCE SIGNALS FOR AN IDLE MODE OR INACTIVE STATE USER EQUIPMENT

(71) Applicant: QUALCOMM Incorporated, San Diego, CA (US)

(72) Inventors: Yuwei REN, Beijing (CN); Huilin XU, Temecula, CA (US); Hung Dinh LY, San Diego, CA (US)

(21) Appl. No.: 18/253,741

(22) PCT Filed: Jan. 12, 2021
(86) PCT No.: PCT/CN2021/071190

§ 371 Date: May 19, 2023

(51) Int. Cl. H04W 52/02

(52) U.S. Cl. CPC H04W 52/0216

(57) ABSTRACT

Various aspects of the present disclosure generally relate to wireless communication. In some aspects, a user equipment (UE) may receive, from a New Radio (NR) base station, an indication that includes a configuration for at least one reference signal. The UE may measure, while in an idle mode or inactive state, the at least one reference signal based at least in part on the indication of the configuration. In some aspects, the UE may further receive, from the NR base station, an activation associated with the at least one reference signal. The at least one reference signal may be measured based at least in part on the activation. Numerous other aspects are described.

### FIELD OF THE DISCLOSURE

Aspects of the present disclosure generally relate to wireless communication and to techniques and apparatuses for configuring reference signals for an idle mode or inactive state user equipment.

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory and one or more processors operatively coupled to the memory, the memory and the one or more processors configured to receive, from a New Radio (NR) base station, an indication that includes a configuration for at least one reference signal; and measure, while in an idle mode or inactive state, the at least one reference signal based at least in part on the indication of the configuration.

In some aspects, a base station for wireless communication includes a memory and one or more processors operatively coupled to the memory, the memory and the one or more processors configured to transmit, to an NR UE, an indication that includes a configuration for at least one reference signal; and transmit, to the NR UE while the NR UE is in an idle mode or inactive state, the at least one reference signal based at least in part on the indication of the configuration.

In some aspects, a method of wireless communication performed by a UE includes receiving, from an NR base station, an indication that includes a configuration for at least one reference signal; and measuring, while in an idle mode or inactive state, the at least one reference signal based at least in part on the indication of the configuration.

In some aspects, a method of wireless communication performed by a base station includes transmitting, to an NR UE, an indication that includes a configuration for at least one reference signal; and transmitting, to the NR UE while the NR UE is in an idle mode or inactive state, the at least one reference signal based at least in part on the indication of the configuration.

In some aspects, a non-transitory computer-readable medium storing a set of instructions for wireless communication includes one or more instructions that, when executed by one or more processors of a UE, cause the UE to: receive, from an NR base station, an indication that includes a configuration for at least one reference signal; and measure, while in an idle mode or inactive state, the at least one reference signal based at least in part on the indication of the configuration.

In some aspects, a non-transitory computer-readable medium storing a set of instructions for wireless communication includes one or more instructions that, when executed by one or more processors of a base station, cause the base station to: transmit, to an NR UE, an indication that includes a configuration for at least one reference signal; and transmit, to the NR UE while the NR UE is in an idle mode or inactive state, the at least one reference signal based at least in part on the indication of the configuration.

In some aspects, an apparatus for wireless communication includes means for receiving, from an NR base station, an indication that includes a configuration for at least one reference signal; and means for measuring, while in an idle mode or inactive state, the at least one reference signal based at least in part on the indication of the configuration.

In some aspects, an apparatus for wireless communication includes means for transmitting, to an NR UE, an indication that includes a configuration for at least one reference signal; and means for transmitting, to the NR UE while the NR UE is in an idle mode or inactive state, the at least one reference signal based at least in part on the indication of the configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIGS. 3A-3B are diagrams illustrating examples of reference signal measurements before paging occasions (POs), in accordance with various aspects of the present disclosure.

FIG. 4 is a diagram illustrating an example associated with configuring reference signals for an idle mode or inactive state UE in NR, in accordance with various aspects of the present disclosure.

FIG. 5 is a diagram illustrating an example associated with activation and deactivation of reference signals for an idle mode or inactive state UE in NR, in accordance with various aspects of the present disclosure.

FIG. 6 is a diagram illustrating an example associated with transmission of reference signals in association with paging of an idle mode or inactive state UE in NR, in accordance with various aspects of the present disclosure.

FIG. 7 is a diagram illustrating an example associated with removing a reference signal configuration from a memory of an idle mode or inactive state UE in NR, in accordance with various aspects of the present disclosure.

FIGS. 8-9 are diagrams illustrating example processes associated with configuring reference signals for an idle mode or inactive state UE, in accordance with various aspects of the present disclosure.

FIGS. 10-11 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

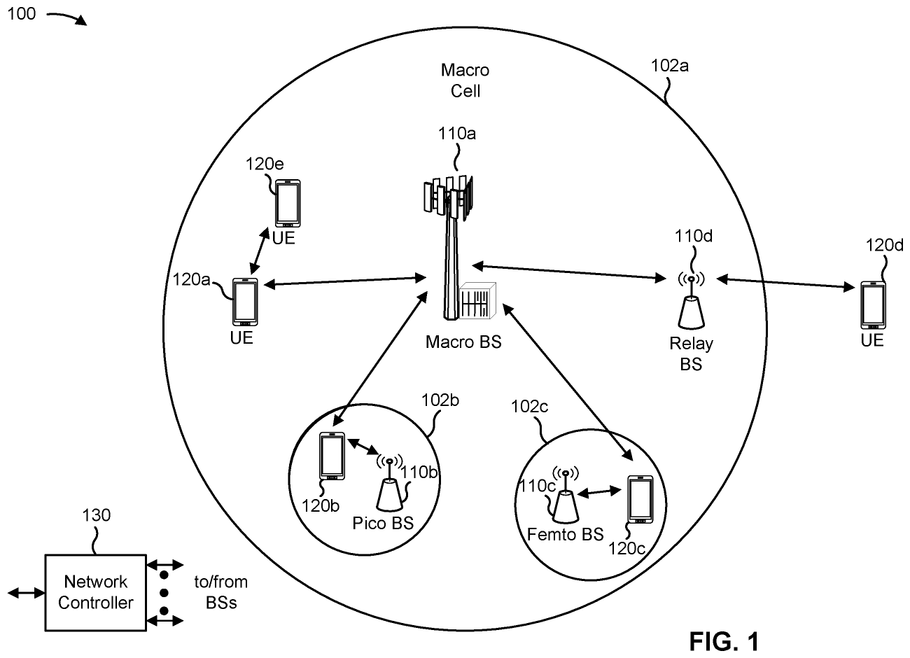

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

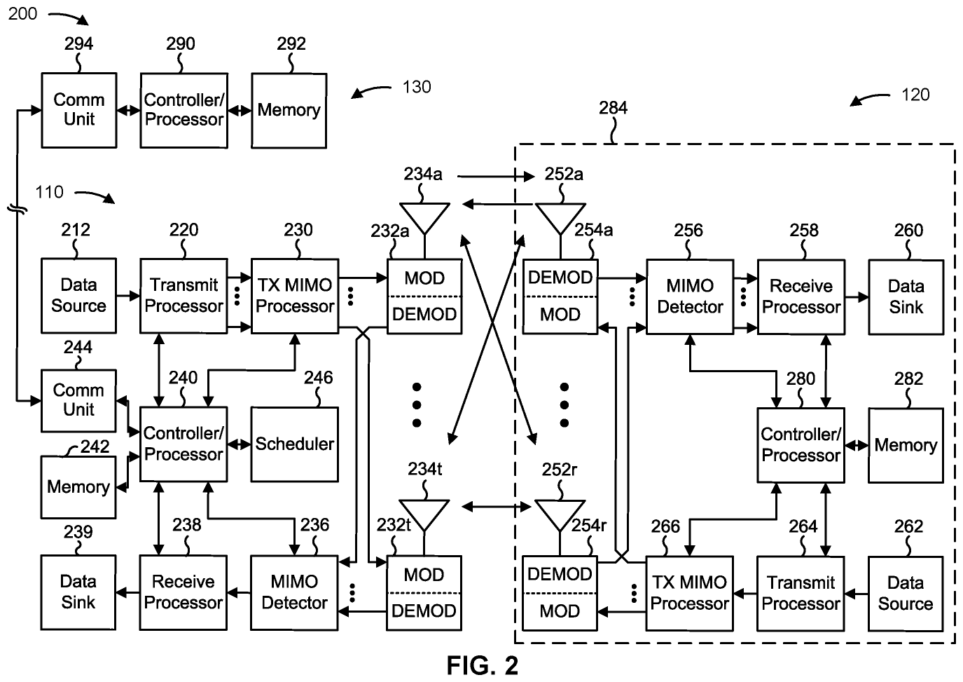

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

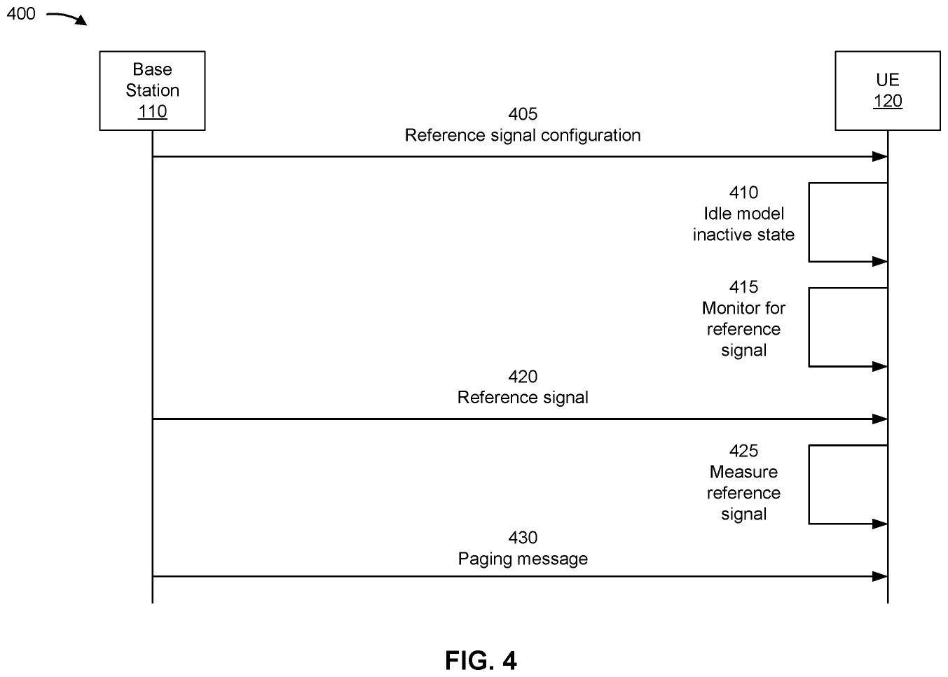

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-9.

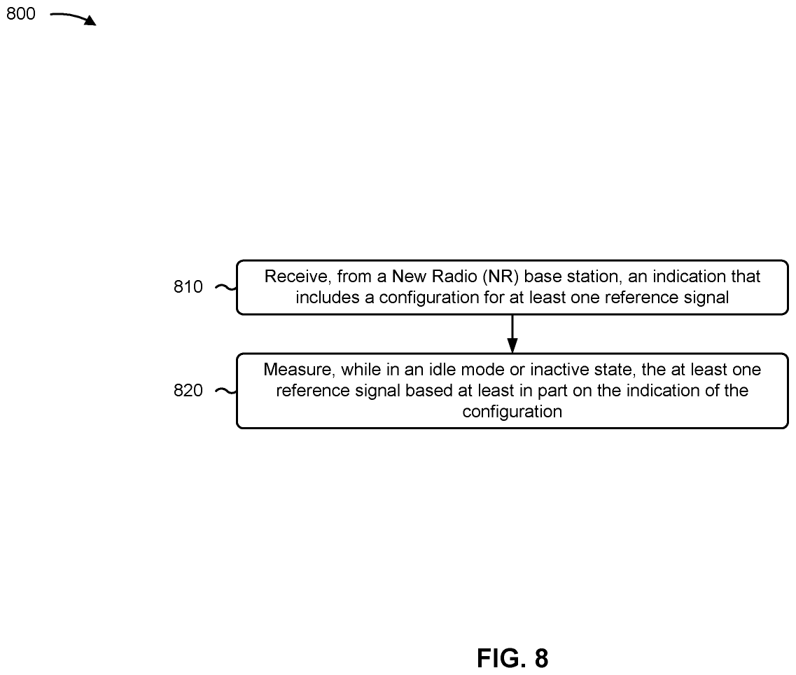

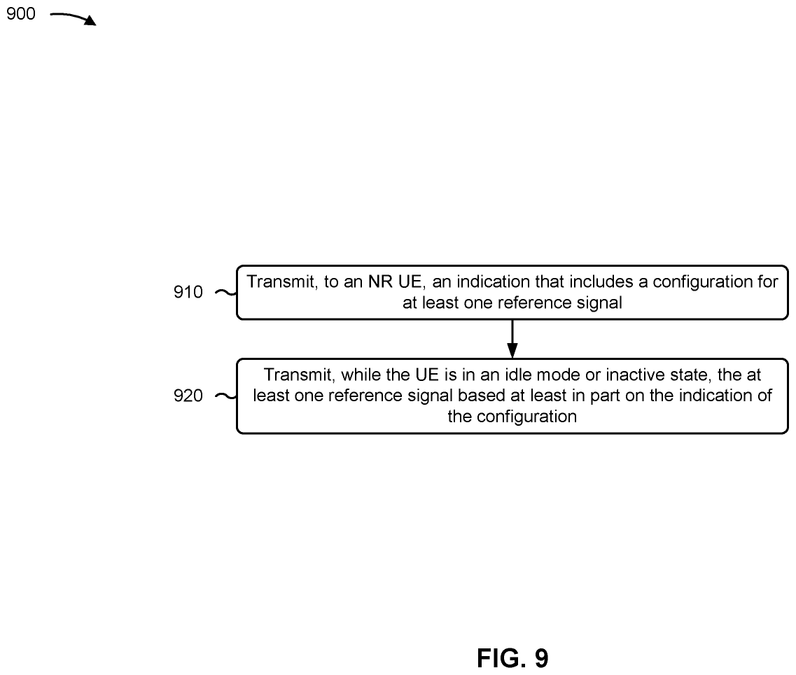

Controller/processor 240 of base station 110, controller/processor 280 of UE 120, and/or any other component(s) of FIG. 2 may perform one or more techniques associated with configuring reference signals for an idle mode or inactive state UE, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

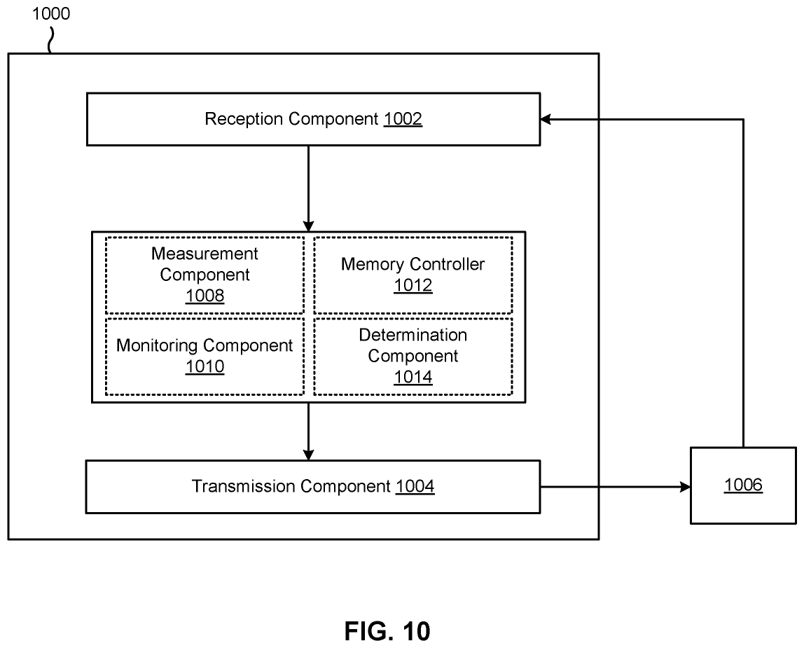

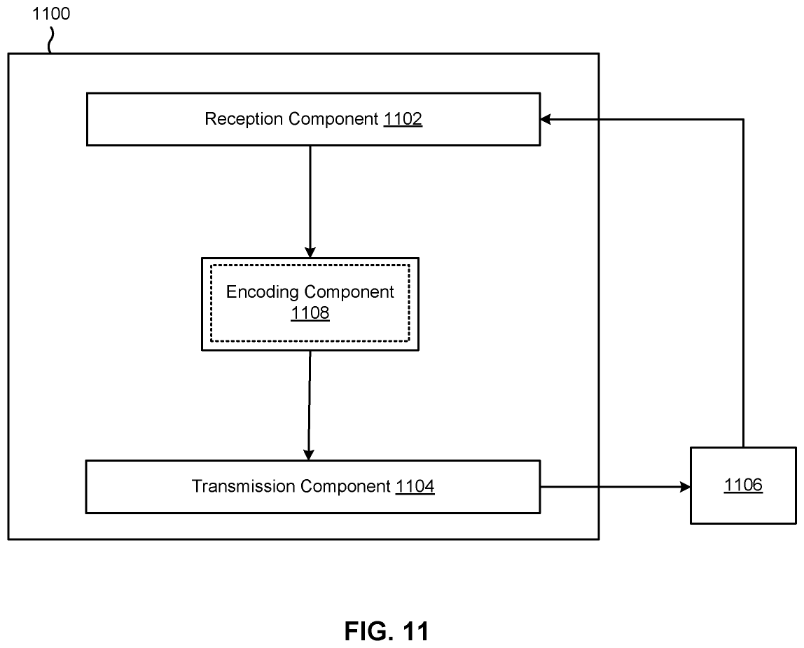

In some aspects, a UE (e.g., UE 120 and/or apparatus 1000 of FIG. 10) may include means for receiving, from an NR base station (e.g., base station 110 and/or apparatus 1100 of FIG. 11), an indication that includes a configuration for at least one reference signal, and/or means for measuring, while in an idle mode or inactive state, the at least one reference signal based at least in part on the indication of the configuration. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE may further include means for monitoring a next paging occasion associated with the UE based at least in part on measurement of the at least one reference signal.

In some aspects, the UE may include means for receiving, from the NR base station, an additional indication that does not include the configuration for the at least one reference signal, and/or means for removing the configuration for the at least one reference signal from the memory of the UE based at least in part on the additional indication. Additionally, or alternatively, the UE may include means for receiving, from the NR base station, an additional indication that includes an instruction to release the configuration for the at least one reference signal, and/or means for removing the configuration for the at least one reference signal from the memory of the UE based at least in part on the additional indication. Additionally, or alternatively, the UE may include means for determining that a timer, associated with the configuration for the at least one reference signal, has expired, and/or means for removing the configuration for the at least one reference signal from the memory of the UE based at least in part on expiry of the timer.

In some aspects, the UE may further include means for transitioning to a connected state with the NR base station, and/or means for removing the configuration for the at least one reference signal from the memory of the UE based at least in part on transitioning to the connected state. Additionally, or alternatively, the UE may include means for establishing a radio resource control (RRC) connection with a new serving cell, and/or means for removing the configuration for the at least one reference signal from the memory of the UE based at least in part on the RRC connection with the new serving cell.

In some aspects, the UE may further include means for using blind detection to measure the at least one reference signal. In some aspects, the UE may further include means for measuring the at least one reference signal within a time window indicated in the configuration for the at least one reference signal, wherein the time window is associated with a next paging occasion for the UE, and/or means for using blind detection to measure the at least one reference signal outside the time window.

In some aspects, the UE may include means for receiving, from the NR base station, an activation associated with the at least one reference signal. Additionally, in some aspects, the UE may include means for using blind detection to measure the at least one reference signal before receiving the activation.

Additionally, or alternatively, the UE may include means for receiving, from the NR base station, a deactivation associated with the at least one reference signal. Additionally, in some aspects, the UE may include means for refraining from measuring the at least one reference signal based at least in part on the deactivation. As an alternative, the UE may include means for using blind detection to measure the at least one reference signal after receiving the deactivation.

In some aspects, the UE may include means for measuring the at least one reference signal after a previous paging occasion and before a next paging occasion for the UE. In some aspects, the UE may include means for receiving, from the NR base station, a paging signal, and means for measuring the at least one reference signal after receiving the paging signal and before receiving an additional paging signal. In some aspects, the UE may include means for receiving, from the NR base station, a paging signal, and means for measuring the at least one reference signal after receiving the paging signal and before a next paging occasion for the UE.

In any of the aspects described above, the UE may include means for receiving, from the NR base station, a message indicating whether the at least one reference signal will be activated and deactivated or whether the at least one reference signal will be transmitted in association with paging of the UE.

In some aspects, a base station (e.g., base station 110 and/or apparatus 1100 of FIG. 11) may include means for transmitting, to an NR UE (e.g., UE 120 and/or apparatus 1000 of FIG. 10), an indication that includes a configuration for at least one reference signal, and/or means for transmitting, to the NR UE while the NR UE is in an idle mode or inactive state, the at least one reference signal based at least in part on the indication of the configuration. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station may further include means for transmitting, to the NR UE, an additional indication that does not include the configuration for the at least one reference signal. Additionally, or alternatively, the base station may include means for transmitting, to the NR UE, an additional indication that includes an instruction to release the configuration for the at least one reference signal.

In some aspects, the base station may include means for transmitting the at least one reference signal within a time window indicated in the configuration for the at least one reference signal, where the time window is associated with a next paging occasion for the NR UE.

In some aspects, the base station may include means for transmitting, to the NR UE, an activation associated with the at least one reference signal. Additionally, or alternatively, the base station may include means for transmitting, to the NR UE, a deactivation associated with the at least one reference signal.

In some aspects, the base station may include means for transmitting the at least one reference signal after a previous paging occasion and before a next paging occasion. In some aspects, the base station includes means for transmitting, to the NR UE, a paging signal, and means for transmitting the at least one reference signal after transmitting the paging signal and before transmitting an additional paging signal. In some aspects, the base station includes means for transmitting, to the NR UE, a paging signal, and means for transmitting the at least one reference signal after transmitting the paging signal and before a next paging occasion.

In any of the aspects described above, the base station may include means for transmitting, to the NR UE, a message indicating whether the at least one reference signal will be activated and deactivated or whether the at least one reference signal will be transmitted in association with paging of the NR UE.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

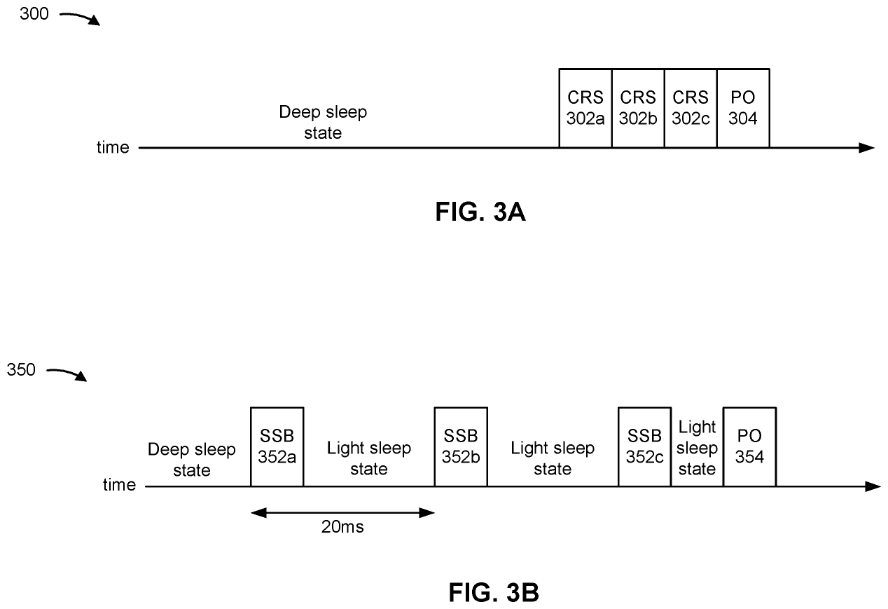

FIG. 3A is a diagram illustrating an example 300 of reference signal measurements before paging occasions (POs) in LTE, in accordance with various aspects of the present disclosure. Example 300 shows signals from a base station to an LTE UE in a time domain. In example 300, the LTE UE may be in an idle mode such that the LTE UE does not have an RRC connection with the base station. Accordingly, the LTE UE may instead wake up to monitor one or more POs. For example, the LTE UE may monitor a physical downlink control channel (PDCCH) for a paging PDCCH message (e.g., encoded as downlink control information (DCI)) that indicates whether a paging physical downlink shared channel (PDSCH) message is scheduled. If the paging PDCCH message does not indicate that a paging PDSCH message is scheduled, the LTE UE may return to the idle mode. If the paging PDCCH message does indicate that a paging PDSCH message is scheduled, the LTE UE may receive and decode the paging PDSCH message and determine if the LTE UE is being paged. If the LTE UE determines that it is being paged, the LTE UE may re-establish an RRC connection with the base station. If the LTE UE determines that it is not being paged, the LTE UE may return to the idle mode.

As shown in FIG. 3A, the LTE UE may measure one or more always-on reference signals, such as a cell-specific reference signal (CRS), transmitted by the base station in each subframe. In example 300, the LTE UE measures the CRS in slots 302a, 302b, and 302c. Thus, the LTE UE may remain in deep sleep until within a few slots or symbols of an upcoming PO 304. As used herein, “slot” may refer to a portion of a subframe, which in turn may be a fraction of a radio frame within an LTE, 5G, or other wireless communication structure. In some aspects, a slot may include one or more symbols. Moreover, “symbol” may refer to an OFDM symbol or another similar symbol within a slot. By measuring the CRS, the LTE UE may update a tracking loop and estimate time delay, frequency offset, and/or other physical properties of signals from the base station before monitoring for a paging PDCCH message in the PO 304 (which may occupy one or more slots).

However, always-on reference signals like a CRS consume unnecessary processing and network resources. In addition, they may reduce quality and/or reliability of communications in a cell due to leakage interference with other signals transmitted within that cell. Accordingly, NR base stations generally do not transmit always-on reference signals like CRSs, as shown in FIG. 3B.

FIG. 3B is a diagram illustrating an example 350 of reference signal measurements before POs in NR, in accordance with various aspects of the present disclosure. Example 350 shows signals from abase station to an NR UE in a time domain. In example 350, the NR UE may be in an idle mode or an inactive state such that the NR UE does not have an RRC connection with the base station. Accordingly, the NR UE may instead wake up to monitor one or more POs. For example, similarly to the LTE UE as described above, the NR UE may monitor a PDCCH for a paging PDCCH message (e.g., encoded as DCI) that indicates whether a paging PDSCH message is scheduled. If the paging PDCCH message does not indicate that a paging PDSCH message is scheduled, the NR UE may return to the idle mode or the inactive state. If the paging PDCCH message does indicate that a paging PDSCH message is scheduled, the NR UE may receive and decode the paging PDSCH message and determine if the NR UE is being paged. If the NR UE determines that it is being paged, the NR UE may reactivate a suspended RRC connection with the base station or re-establish an RRC connection with the base station. If the NR UE determines that it is not being paged, the NR UE may return to the idle mode or the inactive state.

As shown in FIG. 3B, the NR UE may measure a synchronization signal block (SSB) or other periodic signal from the base station because the base station does not transmit an always-on reference signal. In example 350, the NR UE measures the SSB in slots 352a, 352b, and 352c. By measuring the SSB, the NR UE may update a tracking loop and estimate time delay, frequency offset, and/or other physical properties of signals from the base station before monitoring for a paging PDCCH message in the PO 354 (which may occupy one or more slots). However, the NR UE may have to remain in light sleep for multiple radio frames before an upcoming PO 354, because the SSB may be narrow (e.g., transmitted in a limited bandwidth and/or with only 20 resource blocks (RBs)) and/or sparse (e.g., transmitted only every 20 ms, as shown in FIG. 3B). Accordingly, the NR UE may consume more processing resources and battery power as compared with the LTE UE.

Some techniques and apparatuses described herein enable an NR base station (e.g., base station 110) to configure one or more additional reference signals for an NR UE (e.g., UE 120). As a result, the NR base station 110 may conserve processing and networking resources by not transmitting an always-on reference signal, while the NR UE 120 also conserves processing resources and battery life by remaining in deep sleep for longer periods of time before measuring the one or more additional reference signals and then monitoring an upcoming PO.

As indicated above, FIG. 3 is provided as an example. Other examples may differ from what is described with respect to FIG. 3.

FIG. 4 is a diagram illustrating an example 400 associated with configuring reference signals for an idle mode or inactive state UE in NR, in accordance with various aspects of the present disclosure. As shown in FIG. 4, example 400 includes communication between an NR base station 110 and an NR UE 120. In some aspects, the NR base station 110 and the NR UE 120 may be included in a wireless network, such as wireless network 100.

As shown in connection with reference number 405, the NR base station 110 may transmit, and the NR UE 120 may receive, an indication that includes a configuration for at least one reference signal. For example, the indication may include a data structure (e.g., defined in 3GPP specifications and/or another standard) that encodes the configuration. In some aspects, the configuration may include one or more physical resources (e.g., frequencies, beams, and/or other physical properties) associated with the at least one reference signal. Additionally, or alternatively, the configuration may include one or more symbols, slots, or other portions of a time domain in which the at least one reference signal may be transmitted.

In some aspects, at least one reference signal may include a tracking reference signal (TRS), a channel state information reference signal (CSI-RS), and/or another reference signal. In some aspects, the indication of the configuration may be included in a system information block (SIB) message. For example, the NR base station 110 may include the indication in an SIB1 message (e.g., as defined in 3GPP specifications and/or another standard) and/or in another SIB message scheduled by an SIB1 message (e.g., an SIB2 message as defined in 3GPP specifications and/or another standard).

As shown in connection with reference number 410, the NR UE 120 may enter an idle mode or an inactive state. For example, the NR UE 120 may release an RRC connection with the NR base station 110 to enter the idle mode. As an alternative, the NR UE 120 may suspend an RRC connection with the NR base station 110 to enter the inactive state. In some aspects, the NR UE 120 may select an NR cell including the NR base station 110, decode the SIB message and/or other message including the indication of the configuration as part of establishing an RRC connection with the NR base station 110, and transition to the idle mode or inactive state in order to conserve processing resources and battery power.

As shown in connection with reference number 415, the NR UE 120 may monitor for the at least one reference signal. For example, the NR UE 120 may monitor the one or more resources included in the configuration for the at least one reference signal. In some aspects, the NR UE 120 may use blind detection. For example, the NR base station 110 may not always transmit the at least one reference signal; accordingly, the NR UE 120 may have to monitor for the at least one reference signal (e.g., using at least one antenna of the NR UE 120) and determine whether the at least one reference signal was transmitted or not based at least in part on results of that monitoring (e.g., based at least in part on signals from the at least one antenna).

Additionally, or alternatively, the configuration for the at least one reference signal may include a time window. Accordingly, the NR UE 120 may monitor for the at least one reference signal within the time window. In some aspects, the time window may be associated with a next PO for the NR UE 120. For example, the NR base station 110 may indicate a time window between 1 ms and 2 ms before a PO, a time window between 10 slots and 15 slots before a PO, a time window between 144 symbols and 168 symbols before a PO, and/or another time window in which the NR base station 110 will transmit the at least one reference signal. Accordingly, the NR UE 120 may monitor for the at least one reference signal without using blind detection.

In some aspects, the NR UE 120 may additionally use blind detection to monitor for the at least one reference signal outside the time window. For example, the NR base station 110 may additionally transmit the at least one reference signal outside the time window such that the NR UE 120 may detect the at least one reference signal blindly.

In any of the aspects described above, the NR UE 120 may use blind detection based at least in part on a setting stored in a memory of the NR UE 120. For example, the NR UE 120 may be programmed (and/or otherwise preconfigured) to perform blind detection (e.g., outside the time window and/or when the NR base station 110 does not provide a time window). The NR UE 120 may be preconfigured according to 3GPP specifications and/or another standard.

As shown in connection with reference number 420, the NR base station 110 may transmit, and the NR UE 120 may receive, the at least one reference signal based at least in part on the indication of the configuration. For example, as described above, the NR UE 120 may detect the at least one reference signal using blind detection and/or within a time window (e.g., included in the configuration).

As shown in connection with reference number 425, the NR UE 120 may measure the at least one reference signal. For example, the NR UE 120 may update a tracking loop based at least in part on the at least one reference signal. Accordingly, the NR UE 120 may determine a time delay, frequency offset, and/or other physical properties of signals from the NR base station 110.

As shown in connection with reference number 430, the NR base station 110 may transmit, and the NR UE 120 may receive, a paging message. For example, the NR UE 120 may monitor a next PO associated with the NR UE 120 based at least in part on measurement of the at least one reference signal (e.g., as described above in connection with reference number 425). Accordingly, the NR UE 120 may receive a paging PDCCH message in the next PO (which may occupy one or more slots) and receive and decode a corresponding paging PDSCH message to determine if the NR UE 120 is being paged. If the NR UE 120 determines that it is being paged, the NR UE 120 may reactivate a suspended RRC connection with the NR base station 110 or re-establish an RRC connection with the NR base station 110. If the NR UE 120 determines that it is not being paged, the NR UE 120 may return to the idle mode or the inactive state.

By using techniques as described in connection with FIG. 4, the NR base station 110 may configure one or more additional reference signals for the NR UE 120. As a result, the NR base station 110 may conserve processing and networking resources by not transmitting an always-on reference signal, while the NR UE 120 also conserves processing resources and battery life by remaining in deep sleep for longer periods of time before measuring the one or more additional reference signals and then monitoring an upcoming PO.

As indicated above, FIG. 4 is provided as an example. Other examples may differ from what is described with respect to FIG. 4.

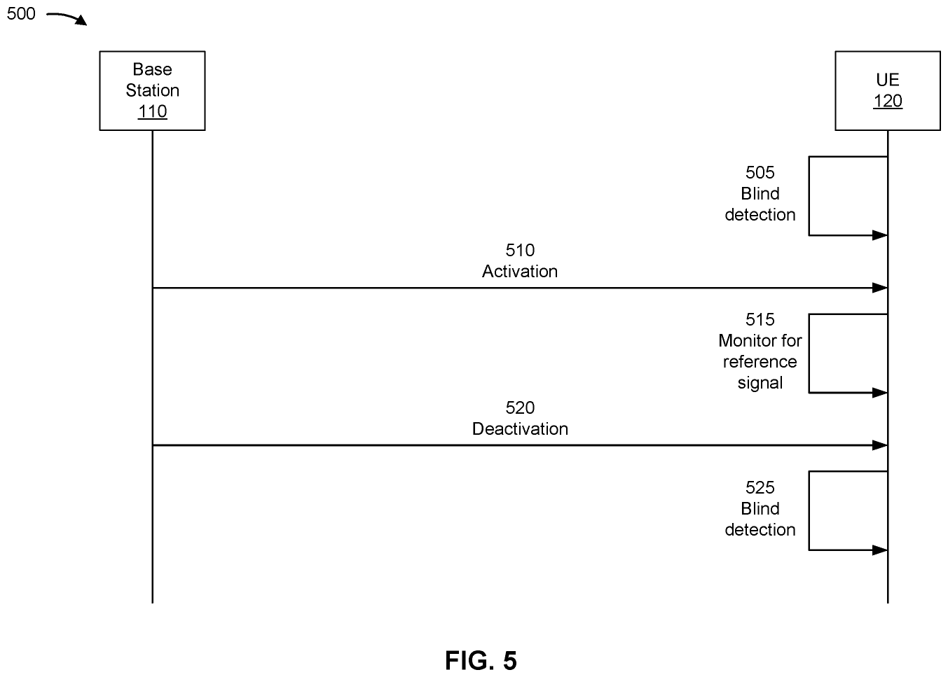

FIG. 5 is a diagram illustrating an example 500 associated with activation and deactivation of reference signals for an idle mode or inactive state UE in NR, in accordance with various aspects of the present disclosure. As shown in FIG. 5, example 500 includes communication between an NR base station 110 and an NR UE 120. In some aspects, the NR base station 110 and the NR UE 120 may be included in a wireless network, such as wireless network 100.

In some aspects, the NR base station 110 may transmit, and the NR UE 120 may receive, an indication that includes a configuration for at least one reference signal (e.g., as described above in connection with reference number 405 of FIG. 4). In some aspects, the indication may also serve as an activation associated with the at least one reference signal. Accordingly, the NR base station 110 may transmit the at least one reference signal (e.g., within a time window as described above in connection with FIG. 4) based at least in part on indication of the configuration.

As an alternative, and as described below, the NR base station 110 may activate the at least one reference signal separately (e.g., using a separate message) from transmitting the indication of the configuration. Accordingly, in some aspects, and as shown in connection with reference number 505, the NR UE 120 may use blind detection to monitor for the at least one reference signal before receiving an activation associated with the at least one reference signal. For example, the NR base station 110 may not always transmit the at least one reference signal; accordingly, the NR UE 120 may have to monitor for the at least one reference signal (e.g., using at least one antenna of the NR UE 120) and determine whether the at least one reference signal was transmitted or not based at least in part on results of that monitoring (e.g., based at least in part on signals from the at least one antenna). As an alternative, the NR UE 120 may refrain from monitoring for the at least one reference signal until receiving an activation associated with the at least one reference signal.

As shown in connection with reference number 510, the NR base station 110 may transmit, and the NR UE 120 may receive, an activation associated with the at least one reference signal. For example, the activation may include a data structure (e.g., defined in 3GPP specifications and/or another standard) that encodes a bit indicating activation (e.g., by being set to 1 or TRUE), an index associated with the at least one reference signal, and/or another indicator that the at least one reference signal is activated. In some aspects, the activation may be included in an SIB message (e.g., an SIB1 message, as defined in 3GPP specifications and/or another standard, and/or in another SIB message scheduled by an SIB1 message), a paging early indication (e.g., a signal transmitted prior to a PO indicating that the NR UE 120 will be paged during that PO), a paging PDCCH message, and/or another similar message.

In some aspects, the activation may indicate that the at least one reference signal will be transmitted once before a next PO for the NR UE 120. For example, the activation may indicate that the NR base station 110 will transmit the at least one reference signal in a time window with respect to the next PO (e.g., as described above in connection with FIG. 4). The NR base station 110 may halt transmission of the at least one reference signal after the next PO such that the activation is temporary.

As an alternative, the activation may indicate that the at least one reference signal will be transmitted a plurality of times before a plurality of POs for the NR UE 120. For example, the activation may indicate that the NR base station 110 will transmit the at least one reference signal in a time window with respect to each PO (e.g., as described above in connection with FIG. 4). In some aspects, the activation may further indicate a duration in which the at least one reference signal will be transmitted (e.g., within the time window for all POs in the next 10 ms, 11 ms, or the like) and/or a number of POs before which the at least one reference signal will be transmitted (e.g., within the time window for the next 5 POs, 6 POs, and so on). The NR base station 110 may halt transmission of the at least one reference signal after the plurality of POs such that the activation is temporary.

As an alternative, the activation may indicate that the at least one reference signal will be transmitted periodically until deactivation. For example, the activation may indicate that the NR base station 110 will transmit the at least one reference signal every 5 ms, every 6 ms, and so on. Additionally, or alternatively, the activation may indicate that the NR base station 110 will transmit the at least one reference signal in a time window with respect to every PO. Accordingly, the activation may be persistent.

As shown in connection with reference number 515, the NR UE 120 may monitor for the at least one reference signal based at least in part on the activation. For example, the NR UE 120 may monitor the one or more resources, included in the configuration for the at least one reference signal, after receiving the activation from the NR base station 110.

In some aspects, the NR UE 120 may fail to receive or decode the activation. Accordingly, in some aspects, the NR UE 120 may determine whether to monitor for the at least one reference signal based at least in part on a current status of the at least one reference signal. For example, if the at least one reference signal had been previously deactivated or never activated, the NR UE 120 may continue not to monitor for the at least one reference signal (or to use blind detection). As another example, if the at least one reference signal had been previously activated (e.g., temporarily, as described above), the NR UE 120 may continue to monitor for the at least one reference signal.

As an alternative, the NR UE 120 may assume activation when the NR UE 120 fails to receive or decode the activation. Accordingly, the NR UE 120 may monitor for the at least one reference signal. As an alternative, the NR UE 120 may assume deactivation when the NR UE 120 fails to receive or decode the activation. Accordingly, the NR UE 120 may not monitor for the at least one reference signal.

As shown in connection with reference number 520, the NR base station 110 may transmit, and the NR UE 120 may receive, a deactivation associated with the at least one reference signal. For example, the deactivation may include a data structure (e.g., defined in 3GPP specifications and/or another standard) that encodes a bit indicating deactivation (e.g., by being set to 0 or FALSE), an index associated with the at least one reference signal, and/or another indicator that the at least one reference signal is deactivated. In some aspects, the deactivation may be included in an SIB message (e.g., an SIB1 message, as defined in 3GPP specifications and/or another standard, and/or in another SIB message scheduled by an SIB1 message), a paging early indication, a paging PDCCH message, and/or another similar message.

In some aspects, the deactivation may indicate that the at least one reference signal will not be transmitted once before a next PO for the NR UE 120. For example, the deactivation may indicate that the NR base station 110 will not transmit the at least one reference signal before the next PO. The NR base station 110 may resume transmission of the at least one reference signal after the next PO such that the deactivation is temporary.

As an alternative, the deactivation may indicate that the at least one reference signal will not be transmitted a plurality of times before a plurality of POs for the NR UE 120. For example, the deactivation may indicate that the NR base station 110 will not transmit the at least one reference signal before a last PO of the plurality of POs. In some aspects, the deactivation may further indicate a duration in which the at least one reference signal will not be transmitted (e.g., not for the next 10 ms, 11 ms, and so on) and/or a number of POs before which the at least one reference signal will not be transmitted (e.g., not until a last PO of the next 5 POs, 6 POs, and so on). The NR base station 110 may resume transmission of the at least one reference signal after the plurality of POs such that the deactivation is temporary.

As an alternative, the deactivation may indicate that the at least one reference signal will not be transmitted until activation. Accordingly, the deactivation may be persistent.

In some aspects, the NR UE 120 may fail to receive or decode the deactivation. Accordingly, in some aspects, the NR UE 120 may determine whether to monitor for the at least one reference signal based at least in part on a current status of the at least one reference signal. For example, if the at least one reference signal had been previously activated or had not been deactivated, the NR UE 120 may continue to monitor for the at least one reference signal. As another example, if the at least one reference signal had been previously deactivated (e.g., temporarily, as described above), the NR UE 120 may continue not to monitor for the at least one reference signal (or to use blind detection).

As an alternative, the NR UE 120 may assume deactivation when the NR UE 120 fails to receive or decode the deactivation. Accordingly, the NR UE 120 may not monitor for the at least one reference signal. As an alternative, the NR UE 120 may assume activation when the NR UE 120 fails to receive or decode the deactivation. Accordingly, the NR UE 120 may monitor for the at least one reference signal.

In some aspects, and as shown in connection with reference number 525, the NR UE 120 may use blind detection to monitor for the at least one reference signal after receiving the deactivation associated with the at least one reference signal. For example, the NR base station 110 may sometimes transmit the at least one reference signal, even after deactivation; accordingly, the NR UE 120 may monitor for the at least one reference signal (e.g., using at least one antenna of the NR UE 120) and determine whether the at least one reference signal was transmitted or not based at least in part on results of that monitoring (e.g., based at least in part on signals from the at least one antenna). As an alternative, the NR UE 120 may refrain from monitoring for the at least one reference signal after receiving the deactivation associated with the at least one reference signal.

By using techniques as described in connection with FIG. 5, the NR base station 110 may activate and deactivate one or more additional reference signals for the NR UE 120. As a result, the NR base station 110 may conserve processing and networking resources by not transmitting an always-on reference signal, while the NR UE 120 also conserves processing resources and battery life by remaining in deep sleep for longer periods of time before measuring the one or more additional reference signals and then monitoring an upcoming PO.

As indicated above, FIG. 5 is provided as an example. Other examples may differ from what is described with respect to FIG. 5.

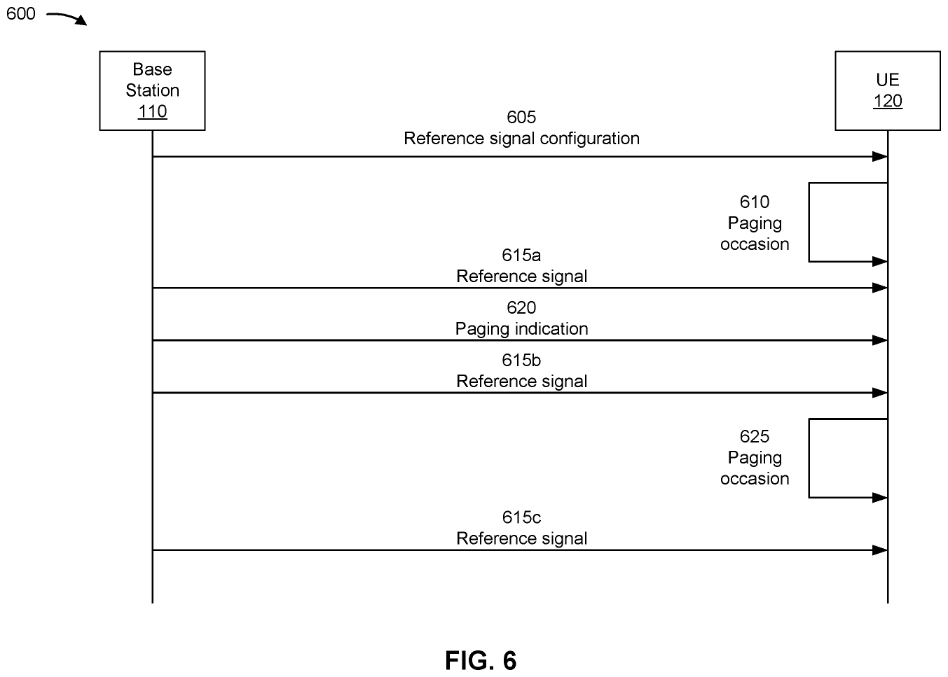

FIG. 6 is a diagram illustrating an example 600 associated with transmission of reference signals in association with paging of an idle mode or inactive state UE in NR, in accordance with various aspects of the present disclosure. As shown in FIG. 6, example 600 includes communication between an NR base station 110 and an NR UE 120. In some aspects, the NR base station 110 and the NR UE 120 may be included in a wireless network, such as wireless network 100.

As shown in connection with reference number 605, the NR base station 110 may transmit, and the NR UE 120 may receive, an indication that includes a configuration for at least one reference signal (e.g., as described above in connection with reference number 405 of FIG. 4). In some aspects, the configuration for the at least one reference signal may include a time window associated with a next PO for the NR UE 120 (e.g., a first PO as described below in connection with reference number 610). For example, the NR base station 110 may indicate a time window between 1 ms and 2 ms before a PO, a time window between 10 slots and 15 slots before a PO, a time window between 144 symbols and 168 symbols before a PO, and/or another time window in which the NR base station 110 will transmit the at least one reference signal. Additionally, in some aspects, the NR UE 120 may enter an idle mode or an inactive state.

As shown in connection with reference number 610, the NR UE 120 may monitor a first PO. For example, the NR UE 120 may monitor for a paging PDCCH message in the first PO. If the NR UE 120 receives the paging PDCCH, the NR UE 120 may receive and decode a corresponding paging PDSCH message to determine if the NR UE 120 is being paged. If the NR UE 120 determines that it is being paged, the NR UE 120 may reactivate a suspended RRC connection with the NR base station 110 or re-establish an RRC connection with the NR base station 110. If the NR UE 120 determines that it is not being paged, the NR UE 120 may return to the idle mode or the inactive state.

As shown in connection with reference number 615a, the NR base station 110 may transmit, and the NR UE 120 may receive, the at least one reference signal between the first PO and a second PO (as described below in connection with reference number 625). Accordingly, the NR UE 120 may measure the at least one reference signal after a previous PO (e.g., the first PO) and before a next PO (e.g., the second PO) for the NR UE 120.

As shown in connection with reference number 620, the NR base station 110 may transmit, and the NR UE 120 may receive, a paging signal. The paging signal may indicate that the NR UE 120 will be paged at a next PO (e.g., the second PO as described below in connection with reference number 625). For example, the signal may be a paging early indication as defined in 3GPP specifications and/or another standard. As an alternative, the signal may be a PDCCH message (e.g., encoded as DCI) associated with the second PO.

Accordingly, in some aspects, and as shown in connection with reference number 615b, the NR base station 110 may transmit, and the NR UE 120 may receive, the at least one reference signal after receiving the paging signal (as described above in connection with reference number 620) and before a next PO for the NR UE 120 (e.g., the second PO as described below in connection with reference number 625). Accordingly, the NR UE 120 may measure the at least one reference signal after receiving the paging signal but before the PO associated with that paging signal.

As shown in connection with reference number 625, the NR UE 120 may monitor a second PO. For example, the NR UE 120 may monitor for a paging PDCCH message in the second PO. If the NR UE 120 receives the paging PDCCH, the NR UE 120 may receive and decode a corresponding paging PDSCH message to determine if the NR UE 120 is being paged. If the NR UE 120 determines that it is being paged, the NR UE 120 may reactivate a suspended RRC connection with the NR base station 110 or re-establish an RRC connection with the NR base station 110. If the NR UE 120 determines that it is not being paged, the NR UE 120 may return to the idle mode or the inactive state.

As shown in connection with reference number 615c, the NR base station 110 may transmit, and the NR UE 120 may receive, the at least one reference signal after receiving the paging signal (as described above in connection with reference number 620) and before one or more symbols in which an additional paging signal (e.g., associated with another PO, such as a third PO) is expected. Accordingly, the NR UE 120 may measure the at least one reference signal after receiving the paging signal but before receiving an additional paging signal.

In some aspects, the NR UE 120 may additionally use blind detection to monitor for the at least one reference signal outside one or more expected time windows (e.g., defined with respect to the first PO and the second PO, defined with respect to the paging signal and the second PO, and/or defined with respect to two paging signals, as described above). For example, the NR base station 110 may additionally transmit the at least one reference signal outside the one or more expected time windows such that the NR UE 120 may detect the at least one reference signal blindly.

The NR UE 120 may use blind detection based at least in part on a setting stored in a memory of the NR UE 120. For example, the NR UE 120 may be programmed (and/or otherwise preconfigured) to perform blind detection (e.g., outside the one or more expected time windows). The NR UE 120 may be preconfigured according to 3GPP specifications and/or another standard.

By using techniques as described in connection with FIG. 6, the NR base station 110 may transmit one or more additional reference signals before paging the NR UE 120. As a result, the NR base station 110 may conserve processing and networking resources by not transmitting an always-on reference signal, while the NR UE 120 also conserves processing resources and battery life by remaining in deep sleep for longer periods of time before measuring the one or more additional reference signals and then monitoring an upcoming PO.

In some aspects, the NR base station 110 may determine whether to use the indication that includes the configuration for at least one reference signal as an activation associated with the at least one reference signal (e.g., as described above in connection with FIG. 5), to provide activation and deactivation associated with the at least one reference signal (e.g., as described above in connection with FIG. 5), and/or to transmit the at least one reference signal when the NR UE 120 is paged (e.g., as described in connection with FIG. 6) based at least in part on a stored setting (e.g., according to 3GPP specifications and/or another standard). As an alternative, the NR base station 110 may indicate to the NR UE 120 whether the at least one reference signal will be activated and deactivated or whether the at least one reference signal will be transmitted in association with paging of the NR UE 120. For example, the NR base station 110 may transmit, and the NR UE 120 may receive, a message indicating whether the at least one reference signal will be activated and deactivated or whether the at least one reference signal will be transmitted in association with paging of the NR UE 120. The message may include a data structure (e.g., defined in 3GPP specifications and/or another standard) that includes a codepoint indicating whether the at least one reference signal will be activated and deactivated or whether the at least one reference signal will be transmitted in association with paging of the NR UE 120 and/or another similar indicator. In some aspects, this message may be included in an SIB message (e.g., an SIB1 message, as defined in 3GPP specifications and/or another standard, and/or in another SIB message scheduled by an SIB1 message), a paging early indication, a paging PDCCH message, and/or another similar message.

As indicated above, FIG. 6 is provided as an example. Other examples may differ from what is described with respect to FIG. 6.

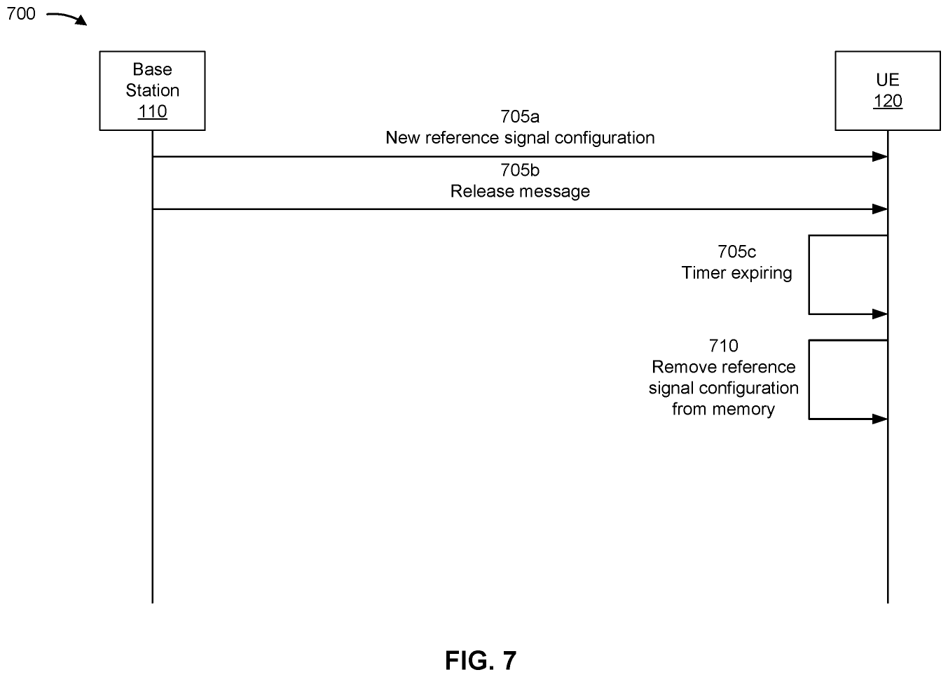

FIG. 7 is a diagram illustrating an example 700 associated with removing a reference signal configuration from a memory of an idle mode or inactive state UE in NR, in accordance with various aspects of the present disclosure. As shown in FIG. 7, example 700 includes communication between an NR base station 110 and an NR UE 120. In some aspects, the NR base station 110 and the NR UE 120 may be included in a wireless network, such as wireless network 100.

In some aspects, the NR base station 110 may transmit, and the NR UE 120 may receive, an indication that includes a configuration for at least one reference signal (e.g., as described above in connection with FIGS. 4, 5, and 6). Accordingly, in some aspects, as shown in connection with reference number 705a, the NR base station 110 may transmit, and the NR UE 120 may receive, an additional indication that does not include the configuration for the at least one reference signal. For example, the NR base station 110 may transmit a new SIB message (e.g., an SIB1 message, as defined in 3GPP specifications and/or another standard, and/or in another SIB message scheduled by an SIB1 message), a new paging early indication (e.g., a signal transmitted prior to a PO indicating that the NR UE 120 will be paged during that PO), a new paging PDCCH message, and/or another similar message that does not include the configuration for the at least one reference signal.

Additionally, or alternatively, and as shown in connection with reference number 705b, the NR base station 110 may transmit, and the NR UE 120 may receive, an additional indication that includes an instruction to release the configuration for the at least one reference signal. For example, the instructions may include a data structure (e.g., defined in 3GPP specifications and/or another standard) that encodes a bit indicating the instruction (e.g., by being set to 1 or TRUE), an index associated with the at least one reference signal, and/or another indicator that the NR UE 120 should release the configuration.

Additionally, or alternatively, and as shown in connection with reference number 705c, the NR UE 120 may determine that a timer, associated with the configuration for the at least one reference signal, has expired. For example, the NR UE 120 may begin a timer (e.g., defined in 3GPP specifications and/or another standard, or configured by the NR base station 110, such as within the indication of the configuration for the at least one reference signal) after receiving the indication of the configuration for the at least one reference signal. In some aspects, the NR UE 120 may further restart the timer when an additional indication from the NR base station 110 includes the configuration again and/or when the NR base station 110 transmits an activation associated with the at least one reference signal.

As shown in connection with reference number 710, the NR UE 120 may remove the configuration for the at least one reference signal from a memory of the NR UE 120. For example, the NR UE 120 may mark one or more memory cells that held the configuration as available for new data. In some aspects, the NR UE 120 may remove the configuration based at least in part on the additional indication from the NR base station 110 (e.g., as described above in connection with reference number 705a). Additionally, or alternatively, the NR UE 120 may remove the configuration based at least in part on the instruction from the NR base station 110 (e.g., as described above in connection with reference number 705b). Additionally, or alternatively, the NR UE 120 may remove the configuration based at least in part on expiry of the timer (e.g., as described above in connection with reference number 705c).

In some aspects, the NR UE 120 may transition to a connected state with the NR base station 110. For example, the NR UE 120 may reactivate a suspended RRC connection with the NR base station 110 or re-establish an RRC connection with the NR base station 110 (e.g., in response to being paged). Accordingly, the NR UE 120 may remove the configuration, from the memory of the NR UE 120, based at least in part on transitioning to the connected state.

Additionally, or alternatively, the NR UE 120 may establish an RRC connection with a new serving cell. For example, the NR UE 120 may be mobile such that the NR UE 120 exits a range associated with a serving cell including the NR base station 110 and enters a range associated with the new serving cell. Accordingly, the NR UE 120 may remove the configuration, from the memory of the NR UE 120, based at least in part on the RRC connection with the new serving cell.

By using techniques as described in connection with FIG. 7, the NR UE 120 may conserve processing resources and battery life by removing reference signal configurations from memory that are no longer activated or otherwise useful to the NR UE 120.

As indicated above, FIG. 7 is provided as an example. Other examples may differ from what is described with respect to FIG. 7.

FIG. 8 is a diagram illustrating an example process 800 performed, for example, by a UE, in accordance with various aspects of the present disclosure. Example process 800 is an example where the UE (e.g., UE 120 and/or apparatus 1000 of FIG. 10) performs operations associated with configuration of reference signals for an idle mode or an inactive state.

As shown in FIG. 8, in some aspects, process 800 may include receiving, from an NR base station (e.g., base station 110 and/or apparatus 1100 of FIG. 11), an indication that includes a configuration for at least one reference signal (block 810). For example, the UE (e.g., using reception component 1002, depicted in FIG. 10) may receive the indication that includes the configuration for the at least one reference signal, as described above.

As further shown in FIG. 8, in some aspects, process 800 may include measuring, while in an idle mode or inactive state, the at least one reference signal based at least in part on the indication of the configuration (block 820). For example, the UE (e.g., using measurement component 1008, depicted in FIG. 10) may measure, while in the idle mode or the inactive state, the at least one reference signal, as described above.

Process 800 may include additional aspects, such as any single aspect or any combination of aspects described below and/or in connection with one or more other processes described elsewhere herein.

In a first aspect, process 800 further includes monitoring (e.g., using monitoring component 1010, depicted in FIG. 10) a next paging occasion associated with the UE based at least in part on measurement of the at least one reference signal.

In a second aspect, alone or in combination with the first aspect, the at least one reference signal includes a TRS, a CSI-RS, or a combination thereof.

In a third aspect, alone or in combination with one or more of the first and second aspects, the indication of the configuration is included in an SIB message.

In a fourth aspect, alone or in combination with one or more of the first through third aspects, process 800 further includes receiving (e.g., using reception component 1002), from the NR base station, an additional indication that does not include the configuration for the at least one reference signal, and removing (e.g., using memory controller 1012, depicted in FIG. 10) the configuration for the at least one reference signal from the memory of the UE based at least in part on the additional indication.

In a fifth aspect, alone or in combination with one or more of the first through fourth aspects, process 800 further includes receiving (e.g., using reception component 1002), from the NR base station, an additional indication that includes an instruction to release the configuration for the at least one reference signal, and removing (e.g., using memory controller 1012) the configuration for the at least one reference signal from the memory of the UE based at least in part on the additional indication.

In a sixth aspect, alone or in combination with one or more of the first through fifth aspects, process 800 further includes determining (e.g., using determination component 1014, depicted in FIG. 10) that a timer, associated with the configuration for the at least one reference signal, has expired, and removing (e.g., using memory controller 1012) the configuration for the at least one reference signal from the memory of the UE based at least in part on expiry of the timer.

In a seventh aspect, alone or in combination with one or more of the first through sixth aspects, process 800 further includes transitioning (e.g., using reception component 1002 and/or transmission component 1004, depicted in FIG. 10) to a connected state with the NR base station, and removing (e.g., using memory controller 1012) the configuration for the at least one reference signal from the memory of the UE based at least in part on transitioning to the connected state.

In an eighth aspect, alone or in combination with one or more of the first through seventh aspects, process 800 further includes establishing (e.g., using reception component 1002 and/or transmission component 1004) an RRC connection with a new serving cell, and removing (e.g., using memory controller 1012) the configuration for the at least one reference signal from the memory of the UE based at least in part on the RRC connection with the new serving cell.

In a ninth aspect, alone or in combination with one or more of the first through eighth aspects, measuring the at least one reference signal comprises using blind detection to measure the at least one reference signal.

In a tenth aspect, alone or in combination with one or more of the first through ninth aspects, blind detection is used based at least in part on a setting stored in the memory of the UE.

In an eleventh aspect, alone or in combination with one or more of the first through tenth aspects, measuring the at least one reference signal comprises measuring the at least one reference signal within a time window indicated in the configuration for the at least one reference signal, where the time window is associated with a next paging occasion for the UE; or using blind detection to measure the at least one reference signal outside the time window.

In a twelfth aspect, alone or in combination with one or more of the first through eleventh aspects, process 800 further includes receiving (e.g., using reception component 1002), from the NR base station, an activation associated with the at least one reference signal, and the at least one reference signal is measured based at least in part on the activation.

In a thirteenth aspect, alone or in combination with one or more of the first through twelfth aspects, process further 800 further includes using blind detection to measure (e.g., using measurement component 1008) the at least one reference signal before receiving the activation.

In a fourteenth aspect, alone or in combination with one or more of the first through thirteenth aspects, the activation is included in an SIB message, a paging early indication, a paging PDCCH message, or a combination thereof.

In a fifteenth aspect, alone or in combination with one or more of the first through fourteenth aspects, the activation indicates that the at least one reference signal will be transmitted once before a next paging occasion for the UE, a plurality of times before a plurality of paging occasions, or periodically until deactivation.

In a sixteenth aspect, alone or in combination with one or more of the first through fifteenth aspects, process 800 further includes receiving (e.g., using reception component 1002), from the NR base station, a deactivation associated with the at least one reference signal.

In a seventeenth aspect, alone or in combination with one or more of the first through sixteenth aspects, process 800 further includes refraining from measuring (e.g., using measurement component 1008) the at least one reference signal based at least in part on the deactivation.

In an eighteenth aspect, alone or in combination with one or more of the first through seventeenth aspects, process 800 further includes using blind detection to measure (e.g., using measurement component 1008) the at least one reference signal after receiving the deactivation.

In a nineteenth aspect, alone or in combination with one or more of the first through eighteenth aspects, the deactivation is included in an SIB message, a paging early indication, a paging PDCCH message, or a combination thereof.

In a twentieth aspect, alone or in combination with one or more of the first through nineteenth aspects, the deactivation indicates that the at least one reference signal will not be transmitted once before a next paging occasion for the UE, a plurality of times before a plurality of paging occasions, or periodically until activation.

In a twenty-first aspect, alone or in combination with one or more of the first through twentieth aspects, measuring the at least one reference signal comprises measuring the at least one reference signal after a previous paging occasion and before a next paging occasion for the UE.

In a twenty-second aspect, alone or in combination with one or more of the first through twenty-first aspects, measuring the at least one reference signal comprises receiving (e.g., using reception component 1002), from the NR base station, a paging signal, and measuring (e.g., using measurement component 1008) the at least one reference signal after receiving the paging signal and before receiving an additional paging signal.

In a twenty-third aspect, alone or in combination with one or more of the first through twenty-second aspects, measuring the at least one reference signal comprises receiving (e.g., using reception component 1002), from the NR base station, a paging signal, and measuring (e.g., using measurement component 1008) the at least one reference signal after receiving the paging signal and before a next paging occasion for the UE.

In a twenty-fourth aspect, alone or in combination with one or more of the first through twenty-third aspects, process 800 further includes receiving (e.g., using reception component 1002), from the NR base station, a message indicating whether the at least one reference signal will be activated and deactivated or whether the at least one reference signal will be transmitted in association with paging of the UE.

In a twenty-fifth aspect, alone or in combination with one or more of the first through twenty-fourth aspects, the message is included in an SIB message, a paging early indication, a paging PDCCH message, or a combination thereof.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with various aspects of the present disclosure. Example process 900 is an example where the base station (e.g., base station 110 and/or apparatus 1100 of FIG. 11) performs operations associated with configuration of reference signals for an idle mode or inactive state UE.

As shown in FIG. 9, in some aspects, process 900 may include transmitting, to an NR UE (e.g., UE 120 and/or apparatus 1000 of FIG. 10), an indication that includes a configuration for at least one reference signal (block 910). For example, the base station (e.g., using transmission component 1104, depicted in FIG. 11) may transmit the indication that includes the configuration for the at least one reference signal, as described above.

As further shown in FIG. 9, in some aspects, process 900 may include transmitting, to the NR UE while the NR UE is in an idle mode or inactive state, the at least one reference signal based at least in part on the indication of the configuration (block 920). For example, the base station (e.g., using transmission component 1104) may transmit the at least one reference signal, as described above.

Process 900 may include additional aspects, such as any single aspect or any combination of aspects described below and/or in connection with one or more other processes described elsewhere herein.

In a first aspect, the at least one reference signal includes a TRS, a CSI-RS, or a combination thereof.

In a second aspect, alone or in combination with the first aspect, the indication of the configuration is included in an SIB message.

In a third aspect, alone or in combination with one or more of the first and second aspects, process 900 further includes transmitting (e.g., using transmission component 1104), to the NR UE, an additional indication that does not include the configuration for the at least one reference signal, where the configuration for the at least one reference signal is removed from a memory of the NR UE based at least in part on the additional indication.

In a fourth aspect, alone or in combination with one or more of the first through third aspects, process 900 further includes transmitting (e.g., using transmission component 1104), to the NR UE, an additional indication that includes an instruction to release the configuration for the at least one reference signal.

In a fifth aspect, alone or in combination with one or more of the first through fourth aspects, transmitting the at least one reference signal comprises transmitting the at least one reference signal within a time window indicated in the configuration for the at least one reference signal, where the time window is associated with a next paging occasion for the NR UE.

In a sixth aspect, alone or in combination with one or more of the first through fifth aspects, process 900 further includes transmitting (e.g., using transmission component 1104), to the NR UE, an activation associated with the at least one reference signal, and the at least one reference signal is transmitted based at least in part on the activation.

In a seventh aspect, alone or in combination with one or more of the first through sixth aspects, the activation is included in an SIB message, a paging early indication, a paging PDCCH message, or a combination thereof.

In an eighth aspect, alone or in combination with one or more of the first through seventh aspects, the activation indicates that the at least one reference signal will be transmitted once before a next paging occasion, a plurality of times before a plurality of paging occasions, or periodically until deactivation.

In a ninth aspect, alone or in combination with one or more of the first through eighth aspects, process 900 further includes transmitting (e.g., using transmission component 1104), to the NR UE, a deactivation associated with the at least one reference signal.

In a tenth aspect, alone or in combination with one or more of the first through ninth aspects, the deactivation is included in an SIB message, a paging early indication, a paging PDCCH message, or a combination thereof.

In an eleventh aspect, alone or in combination with one or more of the first through tenth aspects, the deactivation indicates that the at least one reference signal will not be transmitted once before a next paging occasion, a plurality of times before a plurality of paging occasions, or periodically until activation.

In a twelfth aspect, alone or in combination with one or more of the first through eleventh aspects, transmitting the at least one reference signal comprises transmitting the at least one reference signal after a previous paging occasion and before a next paging occasion.

In a thirteenth aspect, alone or in combination with one or more of the first through twelfth aspects, transmitting the at least one reference signal comprises transmitting (e.g., using transmission component 1104), to the NR UE, a paging signal, and transmitting (e.g., using transmission component 1104) the at least one reference signal after transmitting the paging signal and before transmitting an additional paging signal.

In a fourteenth aspect, alone or in combination with one or more of the first through thirteenth aspects, transmitting the at least one reference signal comprises transmitting (e.g., using transmission component 1104), to the NR UE, a paging signal, and transmitting (e.g., using transmission component 1104) the at least one reference signal after transmitting the paging signal and before a next paging occasion.

In a fifteenth aspect, alone or in combination with one or more of the first through fourteenth aspects, process 900 further includes transmitting (e.g., using transmission component 1104), to the NR UE, a message indicating whether the at least one reference signal will be activated and deactivated or whether the at least one reference signal will be transmitted in association with paging of the NR UE.

In a sixteenth aspect, alone or in combination with one or more of the first through fifteenth aspects, the message is included in an SIB message, a paging early indication, a paging PDCCH message, or a combination thereof.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of a measurement component 1008, a monitoring component 1010, a memory controller 1012, or a determination component 1014, among other examples.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

In some aspects, the reception component 1002 may receive, from the apparatus 1006, an indication that includes a configuration for at least one reference signal. Accordingly, the measurement component 1008 may measure, while apparatus 1000 is in an idle mode or inactive state, the at least one reference signal based at least in part on the indication of the configuration. In some aspects, the measurement component 1008 may include one or more antennas, a demodulator, a MIMO detector, a receive processor, a controller/processor, a memory, or a combination thereof, of the UE described above in connection with FIG. 2.

In some aspects, the monitoring component 1010 may monitor a next paging occasion associated with the apparatus 1000 based at least in part on the measurement component 1008 measuring the at least one reference signal. In some aspects, the monitoring component 1010 may include one or more antennas, a demodulator, a MIMO detector, a receive processor, a controller/processor, a memory, or a combination thereof, of the UE described above in connection with FIG. 2.

In some aspects, the reception component 1002 may receive, from the apparatus 1006, an additional indication that does not include the configuration for the at least one reference signal. Accordingly, the memory controller 1012 may remove the configuration for the at least one reference signal from the memory of the apparatus 1000 based at least in part on the additional indication.

Additionally, or alternatively, the reception component 1002 may receive, from the apparatus 1006, an additional indication that includes an instruction to release the configuration for the at least one reference signal. Accordingly, the memory controller 1012 may remove the configuration for the at least one reference signal from the memory of the apparatus 1000 based at least in part on the additional indication.

Additionally, or alternatively, the determination component 1014 may determine that a timer, associated with the configuration for the at least one reference signal, has expired. In some aspects, the determination component 1014 may include a receive processor, a transmit processor, a controller/processor, a memory, or a combination thereof, of the UE described above in connection with FIG. 2. Accordingly, the memory controller 1012 may remove the configuration for the at least one reference signal from the memory of the apparatus 1000 based at least in part on expiry of the timer.

In some aspects, the reception component 1002 and/or the transmission component 1004 may transition the apparatus 1000 to a connected state with the apparatus 1006. Accordingly, the memory controller 1012 may remove the configuration for the at least one reference signal from the memory of the apparatus 1000 based at least in part on transitioning to the connected state.

In some aspects, the reception component 1002 and/or the transmission component 1004 may establish an RRC connection with a new serving cell. Accordingly, the memory controller 1012 may remove the configuration for the at least one reference signal from the memory of the apparatus 1000 based at least in part on the RRC connection with the new serving cell.

In some aspects, the reception component 1002 may receive, from the apparatus 1006, an activation associated with the at least one reference signal. Accordingly, the measurement component 1008 may measure the at least one reference signal based at least in part on the reception component 1002 receiving the activation.

In some aspects, the measurement component 1008 may use blind detection to measure the at least one reference signal before the reception component 1002 receives the activation.

Additionally, or alternatively, the reception component 1002 may receive, from the apparatus 1006, a deactivation associated with the at least one reference signal. Accordingly, the measurement component 1008 may refrain from measuring the at least one reference signal based at least in part on the deactivation. As an alternative, the measurement component 1008 may use blind detection to measure the at least one reference signal after receiving the deactivation.

In any of the aspects described above, the reception component 1002 may receive, from the apparatus 1006, a message indicating whether the at least one reference signal will be activated and deactivated or whether the at least one reference signal will be transmitted in association with paging of the apparatus 1000.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include an encoding component 1108, among other examples.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

In some aspects, the transmission component 1104 may transmit, to the apparatus 1106, an indication that includes a configuration for at least one reference signal. For example, the encoding component 1108 may encode the indication in an SIB message and/or another message. In some aspects, the encoding component 1108 may include one or more antennas, a modulator, a transmit MIMO processor, a transmit processor, a controller/processor, a memory, or a combination thereof, of the base station described above in connection with FIG. 2. The transmission component 1104 may further transmit, to the apparatus 1106 while the apparatus 1106 is in an idle mode or inactive state, the at least one reference signal based at least in part on the indication of the configuration.

In some aspects, the transmission component 1104 may further transmit, to the apparatus 1106, an additional indication that does not include the configuration for the at least one reference signal. Accordingly, the configuration for the at least one reference signal may be removed from a memory of the apparatus 1106 based at least in part on the additional indication. Additionally, or alternatively, the transmission component 1104 may transmit, to the apparatus 1106, an additional indication that includes an instruction to release the configuration for the at least one reference signal.

In some aspects, the transmission component 1104 may transmit, to the apparatus 1106, an activation associated with the at least one reference signal. Accordingly, the transmission component 1104 may transmit the at least one reference signal based at least in part on the activation.

Additionally, or alternatively, the transmission component 1104 may transmit, to the apparatus 1106, a deactivation associated with the at least one reference signal. Accordingly, the transmission component 1104 may halt transmission of the at least one reference signal based at least in part on the deactivation.

In any of the aspects described above, the transmission component 1104 may transmit, to the apparatus 1106, a message indicating whether the at least one reference signal will be activated and deactivated or whether the at least one reference signal will be transmitted in association with paging of the apparatus 1106.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some aspects of the present disclosure:

Aspect 1: A method of wireless communication performed by a user equipment (UE), comprising: receiving, from a New Radio (NR) base station, an indication that includes a configuration for at least one reference signal; and measuring, while in an idle mode or inactive state, the at least one reference signal based at least in part on the indication of the configuration.

Aspect 2: The method of aspect 1, further comprising: monitoring a next paging occasion associated with the UE based at least in part on measurement of the at least one reference signal.

Aspect 3: The method of any of aspects 1 through 2, wherein the at least one reference signal includes a tracking reference signal (TRS), a channel state information reference signal (CSI-RS), or a combination thereof.

Aspect 4: The method of any of aspects 1 through 3, wherein the indication of the configuration is included in a system information block (SIB) message.

Aspect 5: The method of any of aspects 1 through 4, further comprising: receiving, from the NR base station, an additional indication that does not include the configuration for the at least one reference signal; and removing the configuration for the at least one reference signal from the memory of the UE based at least in part on the additional indication.

Aspect 6: The method of any of aspects 1 through 5, further comprising: receiving, from the NR base station, an additional indication that includes an instruction to release the configuration for the at least one reference signal; and removing the configuration for the at least one reference signal from the memory of the UE based at least in part on the additional indication.

Aspect 7: The method of any of aspects 1 through 6, further comprising: determining that a timer, associated with the configuration for the at least one reference signal, has expired; and removing the configuration for the at least one reference signal from the memory of the UE based at least in part on expiry of the timer.

Aspect 8: The method of any of aspects 1 through 7, further comprising: transitioning to a connected state with the NR base station; and removing the configuration for the at least one reference signal from the memory of the UE based at least in part on transitioning to the connected state.

Aspect 9: The method of any of aspects 1 through 8, further comprising: establishing a radio resource control (RRC) connection with a new serving cell; and removing the configuration for the at least one reference signal from the memory of the UE based at least in part on the RRC connection with the new serving cell.

Aspect 10: The method of any of aspects 1 through 9, wherein measuring the at least one reference signal comprises: using blind detection to measure the at least one reference signal.

Aspect 11: The method of aspect 10, wherein blind detection is used based at least in part on a setting stored in the memory of the UE.

Aspect 12: The method of any of aspects 1 through 9, wherein measuring the at least one reference signal comprises: measuring the at least one reference signal within a time window indicated in the configuration for the at least one reference signal, wherein the time window is associated with a next paging occasion for the UE; or using blind detection to measure the at least one reference signal outside the time window.

Aspect 13: The method of aspect 12, wherein blind detection is used based at least in part on a setting stored in the memory of the UE.

Aspect 14: The method of any of aspects 1 through 13, further comprising: receiving, from the NR base station, an activation associated with the at least one reference signal, wherein the at least one reference signal is measured based at least in part on the activation.

Aspect 15: The method of aspect 14, further comprising: using blind detection to measure the at least one reference signal before receiving the activation.

Aspect 16: The method of any of aspects 14 through 15, wherein the activation is included in an SIB message, a paging early indication, a paging physical downlink control channel (PDCCH) message, or a combination thereof.

Aspect 17: The method of any of aspects 14 through 16, wherein the activation indicates that the at least one reference signal will be transmitted once before a next paging occasion for the UE, a plurality of times before a plurality of paging occasions, or periodically until deactivation.

Aspect 18: The method of any of aspects 1 through 17, further comprising: receiving, from the NR base station, a deactivation associated with the at least one reference signal.

Aspect 19: The method of aspect 18, further comprising: refraining from measuring the at least one reference signal based at least in part on the deactivation.

Aspect 20: The method of any of aspects 18 through 19, further comprising: using blind detection to measure the at least one reference signal after receiving the deactivation.

Aspect 21: The method of any of aspects 18 through 20, wherein the deactivation is included in an SIB message, a paging early indication, a paging PDCCH message, or a combination thereof.

Aspect 22: The method of any of aspects 19 through 21, wherein the deactivation indicates that the at least one reference signal will not be transmitted once before a next paging occasion for the UE, a plurality of times before a plurality of paging occasions, or periodically until activation.

Aspect 23: The method of any of aspects 1 through 22, wherein measuring the at least one reference signal comprises: measuring the at least one reference signal after a previous paging occasion and before a next paging occasion for the UE.

Aspect 24: The method of any of aspects 1 through 23, wherein measuring the at least one reference signal comprises: receiving, from the NR base station, a paging signal; and measuring the at least one reference signal after receiving the paging signal and before receiving an additional paging signal.

Aspect 25: The method of any of aspects 1 through 24, wherein measuring the at least one reference signal comprises: receiving, from the NR base station, a paging signal; and measuring the at least one reference signal after receiving the paging signal and before a next paging occasion for the UE.

Aspect 26: The method of any of aspects 1 through 25, further comprising: receiving, from the NR base station, a message indicating whether the at least one reference signal will be activated and deactivated or whether the at least one reference signal will be transmitted in association with paging of the UE.

Aspect 27: The method of aspect 26, wherein the message is included in an SIB message, a paging early indication, a paging PDCCH message, or a combination thereof.

Aspect 28: A method of wireless communication performed by a base station, comprising: transmitting, to a New Radio (NR) user equipment (UE), an indication that includes a configuration for at least one reference signal; and transmitting, to the NR UE while the NR UE is in an idle mode or inactive state, the at least one reference signal based at least in part on the indication of the configuration.

Aspect 29: The method of aspect 28, wherein the at least one reference signal includes a tracking reference signal (TRS), a channel state information reference signal (CSI-RS), or a combination thereof.

Aspect 30: The method of any of aspects 28 through 29, wherein the indication of the configuration is included in a system information block (SIB) message.

Aspect 31: The method of any of aspects 28 through 30, further comprising: transmitting, to the NR UE, an additional indication that does not include the configuration for the at least one reference signal, wherein the configuration for the at least one reference signal is removed from a memory of the NR UE based at least in part on the additional indication.

Aspect 32: The method of any of aspects 28 through 31, further comprising: transmitting, to the NR UE, an additional indication that includes an instruction to release the configuration for the at least one reference signal.

Aspect 33: The method of any of aspects 28 through 32, wherein transmitting the at least one reference signal comprises: transmitting the at least one reference signal within a time window indicated in the configuration for the at least one reference signal, wherein the time window is associated with a next paging occasion for the NR UE.

Aspect 34: The method of any of aspects 28 through 33, further comprising: transmitting, to the NR UE, an activation associated with the at least one reference signal, wherein the at least one reference signal is transmitted based at least in part on the activation.

Aspect 35: The method of aspect 34, wherein the activation is included in an SIB message, a paging early indication, a paging physical downlink control channel (PDCCH) message, or a combination thereof.

Aspect 36: The method of any of aspects 34 through 35, wherein the activation indicates that the at least one reference signal will be transmitted once before a next paging occasion, a plurality of times before a plurality of paging occasions, or periodically until deactivation.

Aspect 37: The method of any of aspects 28 through 36, further comprising: transmitting, to the NR UE, a deactivation associated with the at least one reference signal.

Aspect 38: The method of aspect 37, wherein the deactivation is included in an SIB message, a paging early indication, a paging PDCCH message, or a combination thereof.

Aspect 39: The method of any of aspects 37 through 38, wherein the deactivation indicates that the at least one reference signal will not be transmitted once before a next paging occasion, a plurality of times before a plurality of paging occasions, or periodically until activation.

Aspect 40: The method of any of aspects 28 through 39, wherein transmitting the at least one reference signal comprises: transmitting the at least one reference signal after a previous paging occasion and before a next paging occasion.

Aspect 41: The method of any of aspects 28 through 40, wherein transmitting the at least one reference signal comprises: transmitting, to the NR UE, a paging signal; and transmitting the at least one reference signal after transmitting the paging signal and before transmitting an additional paging signal.

Aspect 42: The method of any of aspects 28 through 41, wherein transmitting the at least one reference signal comprises: transmitting, to the NR UE, a paging signal; and transmitting the at least one reference signal after transmitting the paging signal and before a next paging occasion.

Aspect 43: The method of any of aspects 28 through 42, further comprising: transmitting, to the NR UE, a message indicating whether the at least one reference signal will be activated and deactivated or whether the at least one reference signal will be transmitted in association with paging of the NR UE.

Aspect 44: The method of aspect 43, wherein the message is included in an SIB message, a paging early indication, a paging PDCCH message, or a combination thereof.

Aspect 45: An apparatus for wireless communication at a device, comprising a processor; memory coupled with the processor; and instructions stored in the memory and executable by the processor to cause the apparatus to perform the method of one or more aspects of aspects 1-27.

Aspect 46: A device for wireless communication, comprising a memory and one or more processors coupled to the memory, the memory and the one or more processors configured to perform the method of one or more aspects of aspects 1-27.

Aspect 47: An apparatus for wireless communication, comprising at least one means for performing the method of one or more aspects of aspects 1-27.

Aspect 48: A non-transitory computer-readable medium storing code for wireless communication, the code comprising instructions executable by a processor to perform the method of one or more aspects of aspects 1-27.

Aspect 49: A non-transitory computer-readable medium storing a set of instructions for wireless communication, the set of instructions comprising one or more instructions that, when executed by one or more processors of a device, cause the device to perform the method of one or more aspects of aspects 1-27.

Aspect 50: An apparatus for wireless communication at a device, comprising a processor; memory coupled with the processor; and instructions stored in the memory and executable by the processor to cause the apparatus to perform the method of one or more aspects of aspects 28-44.

Aspect 51: A device for wireless communication, comprising a memory and one or more processors coupled to the memory, the memory and the one or more processors configured to perform the method of one or more aspects of aspects 28-44.

Aspect 52: An apparatus for wireless communication, comprising at least one means for performing the method of one or more aspects of aspects 28-44.

Aspect 53: A non-transitory computer-readable medium storing code for wireless communication, the code comprising instructions executable by a processor to perform the method of one or more aspects of aspects 28-44.

Aspect 54: A non-transitory computer-readable medium storing a set of instructions for wireless communication, the set of instructions comprising one or more instructions that, when executed by one or more processors of a device, cause the device to perform the method of one or more aspects of aspects 28-44.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE):
one or more memories; and
one or more processors, coupled to the one or more memories, individually or in any combination configured to cause the apparatus to:
receive, from a New Radio (NR) network node, an indication that includes a configuration for at least one reference signal; and
measure, while in an idle mode or inactive state, the at least one reference signal based at least in part on the indication of the configuration.

2. The apparatus of claim 1, wherein the one or more processors individually or in any combination are configured to cause the apparatus to:
monitor a next paging occasion associated with the UE based at least in part on measurement of the at least one reference signal.

3. The apparatus of claim 1, wherein the at least one reference signal includes a tracking reference signal (TRS), a channel state information reference signal (CSI-RS), or a combination thereof.

4. The apparatus of claim 1, wherein the indication of the configuration is included in a system information block (SIB) message.

5-13. (canceled)

14. The apparatus of claim 1, wherein the one or more processors individually or in any combination are configured to cause the apparatus to:
receive, from the NR network node, an activation associated with the at least one reference signal,
wherein the at least one reference signal is measured based at least in part on the activation.

15. (canceled)

16. The apparatus of claim 14, wherein the activation is included in an SIB message, a paging early indication, a paging physical downlink control channel (PDCCH) message, or a combination thereof.

17. The apparatus of claim 14, wherein the activation indicates that the at least one reference signal will be transmitted once before a next paging occasion for the UE, a plurality of times before a plurality of paging occasions, or periodically until deactivation.

18. The apparatus of claim 1, wherein the one or more processors individually or in any combination are configured to cause the apparatus to:
receive, from the NR network node, a deactivation associated with the at least one reference signal.

19. The apparatus of claim 18, wherein the one or more processors individually or in any combination are configured to cause the apparatus to:
refrain from measuring the at least one reference signal based at least in part on the deactivation.

20. (canceled)

21. The apparatus of claim 18, wherein the deactivation is included in an SIB message, a paging early indication, a paging PDCCH message, or a combination thereof.

22-27. (canceled)

28. An apparatus for wireless communication at a network node, comprising:
one or more memories; and
one or more processors, coupled to the one or more memories, individually or in any combination configured to cause the apparatus to:
transmit, to a New Radio (NR) user equipment (UE), an indication that includes a configuration for at least one reference signal; and
transmit, to the NR UE while the NR UE is in an idle mode or inactive state, the at least one reference signal based at least in part on the indication of the configuration.

29. The apparatus of claim 28, wherein the at least one reference signal includes a tracking reference signal (TRS), a channel state information reference signal (CSI-RS), or a combination thereof.

30. The apparatus of claim 28, wherein the indication of the configuration is included in a system information block (SIB) message.

31-33. (canceled)

34. The apparatus of claim 28, wherein the one or more processors individually or in any combination are configured to cause the apparatus to:
transmit, to the NR UE, an activation associated with the at least one reference signal,
wherein the at least one reference signal is transmitted based at least in part on the activation.

35. The apparatus of claim 34, wherein the activation is included in an SIB message, a paging early indication, a paging physical downlink control channel (PDCCH) message, or a combination thereof.

36. The apparatus of claim 34, wherein the activation indicates that the at least one reference signal will be transmitted once before a next paging occasion, a plurality of times before a plurality of paging occasions, or periodically until deactivation.

37. The apparatus of claim 28, wherein the one or more processors individually or in any combination are configured to cause the apparatus to:
transmit, to the NR UE, a deactivation associated with the at least one reference signal.

38-44. (canceled)

45. A method of wireless communication for a user equipment (UE), comprising:
receiving, from a New Radio (NR) network node, an indication that includes a configuration for at least one reference signal; and
measuring, while in an idle mode or inactive state, the at least one reference signal based at least in part on the indication of the configuration.

46. (canceled)

47. The method of claim 45, wherein the at least one reference signal includes a tracking reference signal (TRS), a channel state information reference signal (CSI-RS), or a combination thereof.

48-57. (canceled)

58. The method of claim 45, further comprising:
receiving, from the NR network node, an activation associated with the at least one reference signal,
wherein the at least one reference signal is measured based at least in part on the activation.

59. (canceled)

60. The method of claim 58, wherein the activation is included in an SIB message, a paging early indication, a paging physical downlink control channel (PDCCH) message, or a combination thereof.

61. The method of claim 58, wherein the activation indicates that the at least one reference signal will be transmitted once before a next paging occasion for the UE, a plurality of times before a plurality of paging occasions, or periodically until deactivation.

62. The method of claim 45, further comprising:
receiving, from the NR network node, a deactivation associated with the at least one reference signal.

63. The method of claim 62, further comprising:
refraining from measuring the at least one reference signal based at least in part on the deactivation.

64-71. (canceled)

72. A method of wireless communication for a network node, comprising:
transmitting, to a New Radio (NR) user equipment (UE), an indication that includes a configuration for at least one reference signal; and
transmitting, to the NR UE while the NR UE is in an idle mode or inactive state, the at least one reference signal based at least in part on the indication of the configuration.

73. The method of claim 72, wherein the at least one reference signal includes a tracking reference signal (TRS), a channel state information reference signal (CSI-RS), or a combination thereof.

74-77. (canceled)

78. The method of claim 72, further comprising:
transmitting, to the NR UE, an activation associated with the at least one reference signal,
wherein the at least one reference signal is transmitted based at least in part on the activation.

79. The method of claim 78, wherein the activation is included in an SIB message, a paging early indication, a paging physical downlink control channel (PDCCH) message, or a combination thereof.

80. The method of claim 78, wherein the activation indicates that the at least one reference signal will be transmitted once before a next paging occasion, a plurality of times before a plurality of paging occasions, or periodically until deactivation.

81. The method of claim 72, further comprising:
transmitting, to the NR UE, a deactivation associated with the at least one reference signal.

82-92. (canceled)
